(19) United States
(12) Patent Application Publication
(10) Pub. No.: US 2005/0141620 A1
(43) Pub. Date: Jun. 30, 2005

(54) Decoding apparatus and decoding method

(75) Inventor: Masakazu Hattori, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 10/968,795

(22) Filed: Oct. 19, 2004

(30) Foreign Application Priority Data
Oct. 20, 2003 (JP) P2003-359771

(51) Int. Cl. H04N 7/12

(52) U.S. Cl. 375/240.25; 375/240.24; 375/240.12

(57) ABSTRACT

A video decoder compatible with 4:2:2P@HL is effectively realized. An inter-picture process control section provides information to a decoding processing section regarding which picture is being used as a reference picture. A decode start is also notified to a time management section. An inter-slice process control section determines whether the decoding process is continuing normally, continuing as a simple decoding process, or stopped. This information is sent from the inter-slice process control section to the inter-picture process control section. The time management section generates a decode start time (frame sync signal) and measures a lapsed time after the decode start. When the decode start time comes, the inter-picture process control section is notified of this. In response to a request from the inter-slice process control section, the lapsed time after the decode start and the remaining time until the next frame sync signal is generated are notified.

### CROSS REFERENCE TO RELATED APPLICATIONS

The present application claims priority from Japanese Application No. JP2003-359771, filed in the Japanese Patent Office on Oct. 20, 2003, the disclosure of which is hereby incorporated by reference herein.

### BACKGROUND OF THE INVENTION

The present invention relates to a decoding apparatus and a decoding method suitable for use with a video decoder compatible with, e.g., 4:2:2P@HL. More specifically, a video decoder can be realized which is capable of a real time operation compatible particularly with 4:2:2P@HL by using a realizable circuit scale.

A conventional video decoder compatible with 4:2:2P@HL shortens the total process time by adopting a slice decoder (for example, refer to Japanese Patent Application Publication No. 2001-359107). However, this technique does not describe directly shortening the process time itself as in the present invention.

MPEG2 (Motion Picture Coding Experts Group/Motion Picture Experts Group 2) video is a high efficiency coding scheme for a video signal stipulated in ISO/IEC (International Standards Organization/International Electrotechnical Commission) 13818-2 and ITU-Tsp (International Telecommunication Union—Telecommunication sector) Recommendations H.262.

Encoded streams of MPEG2 are classified in accordance with a profile determined by a coding scheme and a level determined by the number of pixels to be processed, and can deal with a wide range of applications. For example, MP@ML (main•profile•main•level) is one class which is used widely in DVB (Digital Video Broadcast) and DVD (Digital Versatile Disk). The profile and level are described in a sequence_extension to be described later with reference to FIG. 10.

For the production of video signals at a broadcasting station, 4:2:2P (4:2:2 profile) is stipulated which processes video color difference signals by a 4:2:2 profile similar to a conventional baseband and increases the upper limit of the bit rate. HL (high•level) is also stipulated in order to process a high resolution video signal of the next generation.

FIG. 6 shows representative classes of MPEG2 and the upper limit values of various parameters in each class. FIG. 6 shows the upper limit values of the bit rate, the number of samples per line, the number of lines per frame, the frame frequency and a sample process time for each of 4:2:2P@HL (4:2:2 profile•high•level), 4:2:2P@ML (4:2:2 profile•main•level), MP@HL (main•profile•high•level), MP@HL—1440 (main•profile•high•level—1440), MP@ML (main•profile•main•level), MP@LL (main•profile•low•level), and SP@ML (simple•profile•main•level).

As shown in FIG. 6, the upper limit value of the bit rate of 4:2:2P@HL is 300 (Mbit/s) and the upper limit value of the number of pixels to be processed is 62,668,800 (samples/sec). The upper limit value of the bit rate of MP@ML is 15 (Mbit/s) and the upper limit value of the number of pixels to be processed is 10,368,000 (samples/sec). Thus, as compared to a video decoder for decoding MP@ML, it can be seen that a video recorder for decoding 4:2:2P@HL is required to have a twenty fold higher process capability for the bit rate and about a six fold higher rate for the number of pixels to be processed.

FIG. 7 shows the level structure of an MPEG2 video bit stream.

At the start of a picture layer as the highest level layer, a sequence_header is written which defines header data of a sequence of an MPEG bit stream. If a sequence_extension does not follow the sequence_header at the sequence start, the stipulation of ISO-ECE11172-2 is applied to this bit stream. If a sequence_extension follows the sequence_header at the start of the sequence, the sequence-extension follows immediately after all the sequence_headers generated thereafter. Hence, in the example shown in FIG. 7, the sequence_extension follows immediately after all sequence_headers.

The sequence_extension defines extension data of the sequence layer of the MPEG bit stream. The sequence_extension is generated only immediately after the sequence_header, and is not permitted to be placed immediately before a sequence_end_code at the end of the bit stream in order to avoid the loss of a frame after decoding and frame re-ordering. If a sequence_extension is generated in the bit stream, a picture_coding_extension follows immediately after each picture_header.

A GOP (group_of_picture) contains a plurality of pictures. A GOP_header defines header data of a GOP layer in the MPEG bit stream, and a data element defined by a picture_header and a picture_coding_extension is written in the MPEG bit stream. One picture is encoded as picture_data following a picture_header and a picture_coding_extension. The first encoded frame following the GOP_header is an encoded I frame (i.e., the first picture of the GOP_header is an I picture). Although the ITU-T Recommendations H.262 defines various extensions in addition to the sequence_extension and the picture_coding_extension, these are not shown and the descriptions thereof are omitted.

The picture_header defines header data of the picture layer of the MPEG bit stream, and the picture_coding_extension defines extension data of the picture layer of the MPEG bit stream.

Picture_data writes the data elements related to a slice layer and a macro block layer of the MPEG bit stream. As shown in FIG. 7, the picture_data is divided into a plurality of slices and each slice is divided into a plurality of macro_blocks. A macro_block consists of 16×16 pixel data. The start macro block and end macro block are not a skip macro block (a macro block not containing information). The macro block consists of 16×16 pixel data. Each block consists of 8×8 pixel data. The internal structure of a micro block is different between frame coding and field coding of a frame image capable of using a frame DCT (Discrete Cosine Transform) coding and a field DCT coding.

A macro block contains one section of a luminance component and color difference signals. The term “macro block” indicates one of an information source, decoded data and a corresponding encoded data component. A macro block has three color difference formats including 4:2:0, 4:2:2 and 4:4:4. The order of blocks in a macro block is different among these color difference formats.

FIG. 8A shows a macro block of the 4:2:0:profile. In the 4:2:0 profile, the macro block consists of four luminance (Y) blocks and two color difference (Cb, Cr) blocks each consisting of one block. FIG. 8B shows a macro block of the 4:2:2 profile. In the 4:2:2 profile, the macro block consists of four luminance (Y) blocks and two color difference (Cb, Cr) blocks each consisting of two blocks.

Each macro block can be subjected to a prediction encoding process by using any of several methods. A prediction mode is broadly classified into two types, field prediction and frame prediction. Field prediction uses data of one or a plurality of fields previously decoded and predicts each field independently. Frame prediction predicts a frame by using one or a plurality of frames previously decoded. For the field image, the prediction is all by field prediction. For the frame image, prediction is possible by either field prediction or frame prediction, and the prediction method is selected for each macro block. In the prediction coding process for the macro block, in addition to the field prediction and frame prediction, specific prediction modes can be used including 16×8 motion compensation and dual-prime.

Motion vector information and other peripheral information is encoded together with a prediction error signal of each macro block. In encoding a motion vector, the last motion vector encoded by using variable length encoding is used as the prediction vector, and a difference vector from the prediction vector is encoded. The maximum length of a vector capable of being displayed can be programmed for each picture. A motion vector calculation is performed by a coder properly.

Next to the picture_data, a sequence_header and a sequence_extension are disposed. A data element described by the sequence_header and the sequence_extension is the same as the data element described by the sequence_header and sequence_extension written at the start of the sequence of the video stream. The reason why the same data is written in the stream is to prevent the stream from being unable to be decoded, such as the case where, if a bit stream reception apparatus starts receiving the data stream from an intermediate portion thereof (e.g., the bit stream portion corresponding to the picture layer), the data in the sequence layer cannot be received.

At the next data element defined by the last sequence_header and sequence_extension, i.e., at the end of the data stream, a sequence_end_code of 32 bits representative of the end of the sequence is written.

Next, with reference to FIGS. 9 to 12, the details of each data element will be described.

FIG. 9 shows the data structure of the sequence_header. The data elements contained in the sequence_header consist of a sequence_header_code, a horizontal_size_value, a vertical_size_value, an aspect_ratio_information, a frame_rate_code, a bit_rate_value, a marker_bit, a vbv_buffer_size_value, a constrained_parameters_flag, a load_intra_quantiser_matrix, an intra_quantiser_matrix, a load_non_intra_quantiser_matrix, a non_intra_quantiser matrix and the like.

The sequence_header_code is data representative of a start sync code of the sequence layer. The horizontal_size_value is data consisting of the lower 12 bits of the number of pixels of a picture in the horizontal direction. The vertical_size_value is data consisting of the lower 12 bits of the number of vertical lines of a picture. The aspect_ratio_information is data representative of an aspect ratio (a vertical/horizontal ratio) or a display screen aspect ratio. The frame_rate_code is data representative of a display period of a picture. The bit_rate_value is data representative of the lower 18 bits of a bit rate for limiting a generated bit amount.

The marker_bit is bit data to be inserted to prevent start code emulation. The vbv_buffer_size_value is data representative of the lower 10 bits of a value which determines the size of a virtual buffer VBV (Video Buffering Verifier) for the control of a generated code amount. The constrained_parameters_flag is data representative of the fact that each parameter is within limitation. The load_non_intra_quantiser_matrix is data representative of the existence of non-intra MB quantization matrix data. The load_intra_quantiser_matrix is data representative of the existence of intra MB quantization matrix data. The intra_quantiser_matrix is data representative of a value of an intra MB quantization matrix. The non_intra_quantiser_matrix is data representative of a value of a non-intra MB quantization matrix.

FIG. 10 shows the data structure of the sequence_extension. The sequence_extension consists of data elements such as an extension_start_code, an extension_start_code_identifier, a profile_and_level_indication, a progressive_sequence, a chroma_format, a horizontal_size_extension, a vertical_size_extension, a bit_rate_extension, a marker_bit, a vbv_buffer_size_extension, a low_delay, a frame_rate_extension_n and a frame_rate extension_d.

The extension_start_code is data representative of a start sync code of extension data. The extension_start_code_identifier is data representative of which extension data is to be sent. The profile_and_level_indication is data for designating the profile and level of video data. The progressive_sequence is data indicating that the video data is sequential scan (progressive picture). The chroma_format is data for designating a color difference format of the video data. The horizontal_size_extension is data representative of an upper 2 bits to be added to the horizontal_size_value of the sequence header. The vertical_size_extension is data representative of an upper 2 bits to be added to the vertical_size_value of the sequence header.

The bit_rate_extension is data representative of an upper 12 bits to be added to the bit_rate_value of the sequence header. The marker_bit is bit data to be inserted in order to prevent start code emulation. The vbv_buffer_size_extension is data representative of an upper 8 bits to be added to the vbv_buffer_size_value of the sequence header. The low_delay is data indicating that a B picture is not contained. The frame_rate_extension_n is data to be used for acquiring the frame rate, in combination with the frame_rate_code of the sequence header. The frame_rate_extension_d is data to be used for acquiring the frame rate, in combination with the frame_rate_code of the sequence header.

FIG. 11 shows the data structure of the GOP_header. The data elements representative of the GOP_header include a group_start_code, a time_code, a closed_gop and a broken_link.

The group_start_code is data representative of a start sync code of the GOP layer. The time_code is a time code representative of the time of a start picture of the GOP. The closed_gop is flag data indicating that a picture in the GOP can be reproduced independently from other GOPs. The broken_link is flag data indicating that the start B picture in the GOP cannot be reproduced correctly because of editing and the like.

FIG. 12 shows the data structure of the picture_header. The data elements of the picture_header consist of a picture_start_code, a temporal_reference, a picture_coding_type, a vbv_delay, a full_pel_forward_vector, a forward_f_code, a full_pel_backward_vector, a backward_f_code and the like.

The picture_start_code is data representative of a start sync code of the picture layer. The temporal_reference is data representative of a number indicating the display order of a picture, this data being reset at the start of the GOP. The picture_coding_type is data representative of a picture type. The vbv_delay is data representative of an initial state of a virtual buffer during random access. The full_pel_forward_vector, forward_f_code, full_pel_backward_vector and backward_f_code are fixed data not used by MPEG2.

FIG. 13 shows the data structure of the picture_coding_extension. The picture_coding extension consists of an extension_start_code, an extension_start_code_identifier, an f_code[0][0], an f_code[0][1], an f_code[1][0], an f_code[1][1], an intra_dc_precision, a picture_structure, a top_field_first, a frame_pred_frame_dct, concealment_motion_vectors, a q_scale_type, an intra_vlc_format, an alternate_scan, a repeat_first_field, a chroma_{—}420_type, a progressive_frame, a composite_display_flag, a v_axis, a field_sequence, a sub_carrier, a burst_amplitude, a sub_carrier_phase and the like.

The extension_start_code is a start code representative of the start of extension data of the picture layer. The extension_start_code_identifier is a code representative of which extension data is to be sent. The f_code[0][0] is data representative of a horizontal motion vector search range in the forward direction. The f_code[0][1] is data representative of a vertical motion vector search range in the forward direction. The f_code[1][0] is data representative of a horizontal motion vector search range in the backward direction. The f_code[1][1] is data representative of a vertical motion vector search range in the backward direction.

The intra_dc_precision is data representative of the precision of a DC coefficient. A DCT coefficient matrix F of 8×8 can be obtained by making a matrix f indicating luminance and color difference signals of each pixel in the block being subjected to DCT. The coefficient at the upper left corner of this matrix F is called the DC coefficient. The DC coefficient is a signal representative of an average luminance and an average color difference in the block. The picture_structure is data representative of whether the picture structure is a frame structure or a field structure. If the picture structure is a field structure, the picture_structure is also data representative of whether the field structure is an upper field or a lower field. The top_field_first is data representative of whether the first field is upper or lower, if the picture structure is a frame structure. The frame_predictive_frame_dct is data representative of the fact that prediction of a frame mode DCT is in the frame mode only, if the picture structure is the frame structure. The concealment_motion_vectors are data representative of the fact that a motion vector for hiding transmission errors is attached to the intra macro block.

The q_scale_type is data representative of whether a linear quantization scale is used or a non-linear quantization scale is used. The intra_vlc_format is data representative of whether or not another two dimensional VLC (Variable Length Cording) is used for the intra macro block. The alternate_scan is data representative of whether a zigzag scan is used or an alternate scan is used. The repeat_first_field is data to be used when 2:3 pull-down is performed. The chroma_{—}420_type is data representing the same value as the next progressive_frame when the signal format is 4:2:0, and 0 in other cases. The progressive_frame is data representative of whether the picture is a sequential scan or an interlace field. The composite_display_flag is data representative of whether the source signal is a composite signal. The v_axis, field_sequence, sub_carrier, burst_amplitude and sub_carrier_phase are data to be used when the source signal is a composite signal.

FIG. 14 shows the data structure of the picture-data. A data element defined by a picture_data ( ) function is a data element defined by a slice ( ) function. At least one data element defined by the slice ( ) function is written in the bit stream.

As shown in FIG. 15, the slice ( ) function is defined by data elements and a macroblock ( ) function, the data elements including a slice_start_code, a quantiser_scale_code, an intra_slice_flag, an intra-slice, reserved_bits, an extra_bit_slice, an extra_information_slice and the like.

The slice_start_code is a start code representative of the start of data elements defined by the slice ( ) function. The quantiser_scale_code is data representative of a quantization step size set for the macro block existing in the slice layer. If the quantiser_scale_code is set for each micro block, data of a macroblock_quantiser_scale_code set to each macro block is used preferentially.

The intra_slice_flag is a flag representative of whether or not the intra_slice and reserved_bits exist in the bit stream. The intra_slice is data representative of whether or not a non-intra macro block exists in the slice layer. If any one of the macro blocks in the slice layer is a non-intra macro block, the intra_slice is “0”, whereas if all the macro blocks in the slice layer are non-intra macro blocks, the intra_slice becomes “1”. The reserved_bits is data of 7 bits and takes a value of “0”. The extra_bit_slice is a flag indicating that additional information exists, and if the extra_information_slice exists next, it is set to “1”, whereas if additional information does not exist, it is set to “0”.

After these data elements, the data elements defined by the macroblock ( ) function are described. As shown in FIG. 16, the macroblock ( ) function is a function which describes data elements such as a macroblock_escape, a macroblock_address_increment, a quantiser_scale_code and a marker_bit, and the data elements defined by a macroblock_modes ( ) function, a motion_vectors ( ) function and a coded_block_pattern ( ) function.

The macroblock_escape is a fixed bit string representative of whether or not the difference between a reference macro block and a preceding macro block in the horizontal direction is 34 or larger. If the difference between the reference macro block and the preceding macro block in the horizontal direction is 34 or larger, 33 is added to the value of the macroblock_address_increment. The macroblock_address_increment is data representative of the difference between the reference macro block and the preceding macro block in the horizontal direction. If one macroblock_escape exists before the macroblock_address_increment, the value of the macroblock_address_increment added to 33 is data representative of the difference between the actual reference macro block and the preceding macro block in the horizontal direction.

The quantiser_scale_code is data representative of the quantization step size set to each macro block, and exists only when a macroblock_quant is “1”. Although a slice_quantiser_scale_code representative of the quantization step size of the slice layer is set to each slice layer, if a scale_code is set to the reference macro block, this quantization step size is selected.

After the macroblock_address_increment, the data elements defined by the macroblock_modes ( ) function are described. As shown in FIG. 17, the macroblock_modes ( ) function is a function which describes data elements such as a macroblock_type, a frame_motion_type, a field_motion_type and a dct_type. The macroblock_type is data representative of a coding type of the macro block.

If a macroblock_motion_forward or a macroblock_motion_backward is “1”, if the picture structure is a frame, and if a frame_pred_frame_dct is “0”, then a data element representative of the frame_motion_type is described after the data element representative of the macroblock_type. The frame_pred_frame_dct is a flag representative of whether or not the frame_motion_type exists in the bit stream.

The frame_motion_type is a 2-bit code representative of a prediction type of a macro block of the frame. If two prediction vectors exist and the prediction type is a field base, the frame_motion_type is [00], if one prediction vector exists and the prediction type is a field base, the frame_motion_type is [01], if one prediction vector exists and the prediction type is a frame base, the frame_motion_type is [10], and if one prediction vector exists and the prediction type is a dual-prime, the frame_motion_type is [11].

The field_motion_type is a 2-bit code representative of motion prediction of a macro block of the field. If one prediction vector exists and the prediction type is a field base, it takes [01], if two prediction vectors exist and the prediction type is an 18×8 macro block base, it takes [10], and if one prediction vector exists and the prediction type is a dual-prime, it takes [11].

If the picture structure is a frame, if the frame_pred_frame_dct indicates that the frame_motion_type exists in the bit stream and if the frame_pred_frame_dct indicates that the dct_type exists in the bit stream, then the data element representative of the dct_type is described next to the data element representative of the macroblock_type. The dct_type is data representative of whether the DCT is a frame DCT mode or a field DCT mode.

In a stream of MPEG2, each data element described above starts from a special bit pattern called a start code. This start code has a particular bit pattern not appearing in a video stream in another circumstance. Each start code consists of a start code prefix and a start code value to follow. The start code prefix is a bit string “00000000 0000 0000 0000 0001”. The start code value is an integer of 8 bits for identifying the type of the start code.

FIG. 18 shows the value of each start code of MPEG2. Most start codes are represented by one start code value. However, the slice_start_code is represented by a plurality of start code values, 01 to AF, and these start code values represent the vertical position relative to the slice. Since the start codes are all represented by a byte unit, a plurality of bits “0” are inserted before the start code prefix so that the first bit of the start code prefix becomes the first bit of a byte, thus adjusting the start code to make it in byte units.

FIG. 19 is a block diagram showing the circuit structure of a conventional MPEG video decoder compatible with MP@ML. The MPEG video decoder consists of an IC (integrated circuit) 1 and a buffer 2. The IC 1 consists of a stream input circuit 11, a buffer control circuit 12, a clock generation circuit 13, a start code detection circuit 14, a decoder 15, a motion compensation circuit 16 and a display output circuit 17. The buffer 2 consists of a stream buffer 21 and a video buffer 22, and is made of, for example, a DRAM (Dynamic Random Access Memory).

The stream input circuit 11 of IC 1 receives an input of an encoded stream subjected to high efficiency encoding and supplies it to the buffer control circuit 12. The buffer control circuit 12 inputs the encoded stream to the stream buffer 21 of the buffer 2 in response to a basic clock supplied from the clock generation circuit 13. The stream buffer 21 has a capacity of 1,835,008 bits which is a VBV buffer size necessary for decoding of MP@ML. The encoded stream stored in the stream buffer 21 is sequentially read in the order of first write under the control of the buffer control circuit 12, and supplied to the start code detection circuit 14. The start code detection circuit 14 detects the start code described with reference to FIG. 18 from the input stream, and outputs the detected start code and the input stream to the decoder 15.

The decoder 15 decodes the input stream in accordance with the MPEG syntax. In accordance with the input start code, the decoder 15 first decodes the header parameter of the picture layer, and based on the decoded result, separates the slice layer into macro blocks, decodes each macro block, and outputs the prediction vectors and pixels obtained as the decoded results to the motion compensation circuit 16.

MPEG improves coding efficiency by obtaining the motion compensation difference between adjacent pictures by utilizing the time redundancy of the pictures. In the MPEG video decoder, for pixels using motion compensation, pixel data of a reference picture designated by the motion vector is added to the presently decoded pixel to perform motion compensation and decode the image data before encoding.

If the macro block output from the decoder 15 is not subjected to motion compensation, the motion compensation circuit 16 writes the pixel data into the video buffer 22 of the buffer 2 via the buffer control circuit 12 to prepare for a display output and for the case in which the pixel data is used as the reference data of another picture.

If the macro block output from the decoder 15 is subjected to motion compensation, the motion compensation circuit 16 reads the reference pixel data from the video buffer 22 of the buffer 2 via the buffer control circuit 12 in accordance with the prediction vector output from the decoder 15. The read reference pixel data is added to the pixel data supplied from the decoder 15 to perform motion compensation. The motion compensation circuit 16 writes the pixel data subjected to the motion compensation into the video buffer 22 of the buffer 2 via the buffer control circuit 12 to prepare for a display output and for the case in which the pixel data is used as the reference data of another pixel.

The display output circuit 17 generates a sync timing signal to be used when the decoded picture data is output, and based on the timing signal, reads the pixel data from the video buffer 22 via the buffer control circuit 12, and outputs it as the decoded video signal.

As described above, the MPEG2 stream has a hierarchical structure. The amount of data from the sequence_header to the picture_coding_extension of the picture layer described with reference to FIG. 7 is not changed often, even if the different profile and level described with reference to FIG. 6 are used. The data amount of the slice layer and underlying layer is dependent upon the number of pixels subjected to coding.

As seen from FIG. 6, the number of macro blocks to be processed for one picture in HL is about six fold that in ML. Also as seen from FIG. 8, the number of blocks to be processed for one macro block in 4:2:2P is 4/3 times that in MP.

Thus, when the video decoder compatible with MP@ML described with reference to FIG. 19 decodes a 4:2:2P@HL encoded stream, the buffer size of the stream buffer 21 becomes insufficient as the VBV buffer size and the number of pixels increase. As the bit rate increases, access of an input stream to the stream buffer 21 increases, and as the number of pixels increases, access of the motion compensation circuit 16 to the video buffer 22 increases. Therefore, control by the buffer control circuit 12 cannot be realized in time. Further, as the bit rate increases and the number of macro blocks and the number of blocks increase, processing by the decoder 15 cannot be realized in time.

With the recent development of semiconductor technologies, the operation speed of both a signal processing circuit and a memory (buffer) circuit has been improved considerably. However, present ML@MP decoding technologies still cannot decode 4:2:2P@HL. Generally, if signal processing is to be executed at the high speed described above, the circuit scale increases greatly, resulting in an increase in the number of components and in the consumption of power.

In Japanese Patent Application Publication No. 2001-359107 mentioned above, a plurality of decoding means for decoding an encoded stream and decoding control means for controlling the plurality of decoding means to operate in parallel are provided. FIG. 20 is a block diagram showing the circuit structure of an MPEG video decoder described in Japanese Patent Application No. 2001-359107.

The MPEG video decoder shown in FIG. 20 consists of an IC 31 including a stream input circuit 41, a start code detection circuit 42, a stream buffer control circuit 43, a clock generation circuit 44, a picture decoder 45, a slice decoder control circuit 46, slice decoders 47 to 49, a motion compensation circuit 50, a luminance buffer control circuit 51, a color difference buffer control circuit 52 and a display output circuit 53; a buffer 32 including a stream buffer 61 and a start code buffer 62 and made of, for example, a DRAM; a video buffer 33 including a luminance buffer 71 and a color difference buffer 72 and made of, for example, a DRAM; a controller 34; and a drive 35.

The stream input circuit 41 receives an input of an encoded stream subjected to high efficiency encoding and supplies it to the start code detection circuit 42. The start code detection circuit 42 supplies the input encoded stream to the stream buffer control circuit 43, and detects the start code described with reference to FIG. 18, and based on the start code, generates start code information and supplies it to the stream buffer control circuit 43. The start code information includes information on the type of the start code and a write pointer indicating the position in the stream buffer 61 where the start code is written.

The clock generation circuit 44 generates a basic clock two times as fast as that of the clock generation circuit 13 described with reference to FIG. 19, and supplies it to the stream buffer control circuit 43. In accordance with the basic clock supplied from the clock generation circuit 44, the stream buffer control circuit 43 writes the input encoded stream into the stream buffer 61 of the buffer 32, and writes the input start code information into the start code buffer 62 of the buffer 32.

If the MPEG video decoder is structured in such a manner that an MPEG encoded stream of 4:2:2P@HL can be reproduced in the forward direction, the stream buffer 61 has at least a capacity of 47,185,920 bits which is the VBV buffer size necessary for decoding of 4:2:2P@HL. If the MPEG video decoder is structured to be able to execute reverse reproduction, the stream buffer 61 has at least a capacity capable of recording data of 2 GOPs.

The picture decoder 45 reads the start code information from the start code buffer 62 via the stream buffer control circuit 43. For example, when the decoding starts, the decoding starts from the sequence_header described with reference to FIG. 7. Therefore, the picture decoder 45 reads the write pointer corresponding to the sequence_header_code, which is the start code described with reference to FIG. 9, from the start code buffer 62, and based on the write pointer, reads the sequence_header from the stream buffer 61 and decodes it. Next, similar to reading the sequence_header, the picture decoder 45 reads the sequence_extension, GOP_header, picture_coding_extension and the like from the stream buffer 61 and decodes them.

When the picture decoder 45 reads the first slice_start_code from the start code buffer 62, all parameters necessary for decoding the picture are prepared. The picture decoder 45 outputs the decoded parameters of the picture layer to the slice decoder control circuit 46.

The slice decoder control circuit 46 receives an input of parameters of the picture layer, and reads start code information of the corresponding slice from the start code buffer 62 via the stream buffer control circuit 43. The slice decoder control circuit 46 has a register which indicates that the slice to be decoded at any one of the slice decoders 47 to 49 is at what order of the slices contained in the encoded stream. By referring to this register, the slice decoder control circuit 46 supplies one of the slice decoders 47 to 49 with the parameters of the picture layer and the slice write pointer contained in the start code information.

The slice decoder 47 consists of a macro block detection circuit 81, a vector decoding circuit 82, an inverse quantization circuit 83 and an inverse DCT circuit 84. Based on the slice write pointer supplied from the slice decoder control circuit 46, the corresponding slice is read from the stream buffer 61 via the stream buffer control circuit 43. In accordance with the parameters of the picture layer input from the slice decoder control circuit 46, the slice decoder decodes the read slice and outputs the result to the motion compensation circuit 50.

The macro block detection circuit 81 separates the macro blocks of the slice layer, decodes the parameters of each macro block, supplies a prediction mode and prediction vectors of each macro block subjected to variable length encoding to the vector decoding circuit 82 and supplies the coefficient data subjected to variable length encoding to the inverse quantization circuit 83. The vector decoding circuit 82 decodes the prediction mode and prediction vectors of each macro block subjected to variable length encoding to recover the prediction vectors. The inverse quantization circuit 83 decodes the coefficient data subjected to variable length encoding and supplies the result to the inverse DCT circuit 84. The inverse DCT circuit 84 subjects the decoded coefficient data to inverse DCT to recover the pixel data before encoding.

The slice decoder 47 requests that the motion compensation circuit 50 execute motion compensation of the decoded macro block (i.e., a signal indicated by REQ in the drawing is set to 1), and in response to receiving a signal representing acknowledgement of the request for execution of motion compensation from the motion compensation circuit 50 (a signal indicated by ACK in the drawing), supplies the decoded prediction vectors and decoded pixels to the motion compensation circuit 50. The slice decoder 47 receives an input of the ACK signal and supplies the decoded prediction vectors and decoded pixels to the motion compensation circuit 50 to thereafter change the REQ signal from 1 to 0. The REQ signal is again changed from 0 to 1 when decoding of the next input macro block is completed.

A macro block detection circuit 85 to an inverse DCT circuit 88 of the slice decoder 48 and a macro block detection circuit 89 to an inverse DCT circuit 92 of the slice decoder 49 execute similar processes to those of the macro block detection circuit 81 to the inverse DCT circuit 84 of the slice decoder 47, and so the description thereof is omitted.

The motion compensation circuit 50 has three registers Reg_REQ_A, Reg_REQ_B and Reg_REQ_C indicating whether or not the motion compensation of the data input from the slice decoders 47 to 49 has finished. While the values of these registers are referred to, the motion compensation circuit 50 properly selects one of the slice decoders 47 to 49, and accepts the motion compensation execution request (namely, in response to the REQ signal, the ACK signal is output to accept the prediction vectors and pixels) to execute the motion compensation process. In this case, the motion compensation circuit 50 accepts the next motion compensation request after the motion compensation for the slice decoders 47 to 49 having the REQ signal of 1 at a predetermined time is completed once for each of the slice decoders. For example, even if the slice decoder 47 successively issues the motion compensation requests, the second motion compensation request of the slice decoder 47 will not be accepted unless the motion compensation for the slice decoder 48 and slice decoder 49 has been completed.

If the macro block input from any one of the slice decoders 47 to 49 does not use the motion compensation, the motion compensation circuit 50 writes the luminance data into the luminance buffer 71 of the video buffer 33 via the luminance buffer control circuit 51 if the pixel data is luminance data, whereas if the pixel data is color difference data, the motion compensation circuit 50 writes the color difference data in the color difference buffer 72 of the video buffer 33 via the color difference buffer control circuit 52, to thereby prepare for a display output and for the case in which the pixel data is used as the reference data of another picture.

If the macro block input from any one of the slice decoders 47 to 49 uses the motion compensation, in accordance with the prediction vectors input from a corresponding one of the slice decoders 47 to 49, the motion compensation circuit 50 reads the reference pixels from the luminance buffer 71 via the luminance buffer control circuit 51 if the pixel data is luminance data, whereas if the pixel data is color difference data, the motion compensation circuit 50 reads the reference pixel data from the color difference buffer 72 via the color difference buffer control circuit 52. The motion compensation circuit 50 adds the read reference pixel data to the pixel data supplied from any one of the slice decoders 47 to 49 to perform the motion compensation.

The motion compensation circuit 50 writes the pixel data subjected to motion compensation into the luminance buffer 71 via the luminance buffer control circuit 51 if the pixel data is luminance data, whereas if the pixel data is color difference data, the motion compensation circuit 50 writes the color difference data into the color difference buffer 72 via the color difference buffer control circuit 52, to thereby prepare for a display output and for the case in which the pixel data is used as the reference data of another pixel.

The display output circuit 53 generates a sync timing signal to be used when the decoded image data is output, and in response to this timing, reads the luminance data from the luminance buffer 71 via the luminance buffer control circuit 51 and reads the color difference data from the color difference buffer 72 via the color difference buffer control circuit 52, to output them as the decoded video signal.

The drive 35 is connected to the controller 34 and transfers data to and from a magnetic disk 101, an optical disk 102, a magneto optical disk 103, a semiconductor memory 104 or the like mounted on the drive when necessary. The controller 34 also controls the operations of IC 31 and drive 35 described above. For example, the controller 34 can make IC 31 execute processes in accordance with a program stored in the magnetic disk 101, optical disk 102, magneto optical disk 103, semiconductor memory 104 or the like mounted on the drive.

However, even if the above-described slice decoder approach is utilized, decoding is not necessarily completed in a predetermined time in some cases if the picture to be decoded is very complicated. In such cases, conventionally, the decoding process is terminated when a predetermined time (one frame period) lapses, and a countermeasure such as interpolation by the picture of a nearby frame is performed, so that the image quality is inevitably degraded greatly. These processes are also performed for a so-called I picture and P picture, so that there is a fear that serious failures of decoding may occur.

### SUMMARY OF THE INVENTION

The present invention has been made in consideration of these circumstances and effectively realizes a video decoder compatible with 4:2:2P@HL capable of real time operations with a circuit scale capable of being realized by using present semiconductor technologies.

The drawbacks to be solved by this application are inevitable image quality deterioration to a great degree because a conventional apparatus terminates the decoding process when a predetermined time (one frame period) has lapsed, and also serious failures of decoding when this countermeasure is performed for an I picture and a P picture.

According to the present invention, therefore, when decoding digitally compressed and encoded pictures and displaying the decoded pictures in real time, the time during a decoding process is measured; a normal decoding function for performing a normal decoding process and a simple decoding function for performing a simple decoding process are provided, the simple decoding process decoding at a higher speed and in a shorter time than the normal decoding process; a decoding operation is performed with temporary stopping during the decoding process; and in accordance with the measured time, the decoding operation is switched to either the normal decoding process or the simple decoding process during the decoding process. Thus, a video decoder compatible with, for example, 4:2:2P@HL can be realized effectively.

According to a first aspect of the invention, a decoding apparatus to be used in a system that decodes digitally compressed and encoded pictures and displays the decoded pictures in real time includes a decoding control section operable to measure time during a decoding process; and a decoding processing section operable to perform a decoding operation with temporary stopping during the decoding process in cooperation with the decoding control section; wherein the decoding processing section is operable to perform both a normal decoding process and a simple decoding process that decodes at a higher speed and in a shorter time than the normal decoding process, and the decoding control section is operable to switch the decoding operation of the decoding processing section to either the normal decoding process or the simple decoding process during the decoding process. Thus, a video decoder compatible with, for example, 4:2:2P@HL can be realized effectively.

According to a second aspect of the invention, the decoding processing section is operable to stop the decoding operation in each MPEG slice unit of the digitally compressed and encoded pictures, and the decoding control section is operable to switch the decoding operation of the decoding processing section to either the normal decoding process or the simple decoding process in each of the MPEG slice units. Thus, the decoding process in the slice unit can be executed properly.

According to a third aspect of the invention, the decoding processing section is operable to stop the decoding operation in each MPEG macro block unit of the digitally compressed and encoded pictures, and the decoding control section is operable to switch the decoding operation of the decoding processing section to either the normal decoding process or the simple decoding process in each of the MPEG macro block units. Thus, the decoding process in the MPEG macro block unit can be executed properly.

According to a fourth aspect of the invention, only the normal decoding process is used for a specific picture to be used as a reference picture during picture compression/expansion for decoding another picture, and if a decoding process time of the specific picture is longer than a display time of one picture frame, the decoding process times of pictures preceding and subsequent to the specific picture are shortened by the simple decoding process. Thus, decoding with few failures can be realized.

According to a fifth aspect of the invention, a decoding apparatus to be used in a system that decodes digitally compressed and encoded pictures and displays the decoded pictures in real time includes a decoding control section operable to measure time during a decoding process; and a decoding processing section operable to perform a decoding operation with temporary stopping during the decoding process in cooperation with the decoding control section; wherein the decoding processing section is operable to perform both a normal decoding process and a simple decoding process that decodes a bidirectional prediction macro block of MPEG at a higher speed and in a shorter time than the normal decoding process by using only one of two reference pictures, and the decoding control section is operable to switch the decoding operation of the decoding processing section to either the normal decoding process or the simple decoding process during the decoding process. Thus, a video decoder compatible with, for example, 4:2:2P@HL can be realized effectively.

According to a sixth aspect of the invention, the decoding processing section is operable to stop the decoding operation in each MPEG slice unit of the digitally compressed and encoded pictures, and the decoding control section is operable to switch the decoding operation of the decoding processing section to either the normal decoding process or the simple decoding process in each of the MPEG slice units. Thus, the decoding process in the slice unit can be executed properly.

According to a seventh aspect of the invention, the decoding processing section is operable to stop the decoding operation in each MPEG macro block unit of the digitally compressed and encoded pictures, and the decoding control section is operable to switch the decoding operation of the decoding processing section to either the normal decoding process or the simple decoding process in each of the MPEG macro block units. Thus, the decoding process in the micro block unit can be executed properly.

According to an eighth aspect of the invention, only the normal decoding process is used for a specific picture to be used as a reference picture during picture compression/expansion for decoding another picture, and if a decoding process time of the specific picture is longer than a display time of one picture frame, the decoding process times of pictures preceding and subsequent to the specific picture are shortened by the simple decoding process. Thus, decoding with few failures can be realized.

According to a ninth aspect of the invention, a decoding method to be used in a system that decodes digitally compressed and encoded pictures and displays the decoded pictures in real time includes measuring time during a decoding process; providing a normal decoding function for performing a normal decoding process and a simple decoding function for performing a simple decoding process, the simple decoding process decoding at a higher speed and in a shorter time than the normal decoding process; performing a decoding operation with temporary stopping during the decoding process; and in accordance with the measured time, switching the decoding operation to either the normal decoding process or the simple decoding process during the decoding process. Thus, a video decoder compatible with, for example, 4:2:2P@HL can be realized effectively.

According to a tenth aspect of the invention, the decoding method further includes stopping the decoding operation in each MPEG slice unit of the digitally compressed and encoded pictures; and switching the decoding operation to either the normal decoding process or the simple decoding process in each of the MPEG slice units. Thus, the decoding process in the slice unit can be executed properly.

According to an eleventh aspect of the invention, the decoding method further includes stopping the decoding operation in each MPEG macro block unit of the digitally compressed and encoded pictures; and switching the decoding operation to either the normal decoding process or the simple decoding process in each of the MPEG macro block units. Thus, the decoding process in the macro block unit can be executed properly.

According to a twelfth aspect of the invention, only the normal decoding process is used for a specific picture to be used as a reference picture during picture compression/expansion for decoding another picture, and if a decoding process time of the specific picture is longer than a display time of one picture frame, the decoding process times of pictures preceding and subsequent to the specific picture are shortened by the simple decoding process. Thus, decoding with few failures can be realized.

According to a thirteenth aspect of the invention, a decoding method to be used in a system that decodes digitally compressed and encoded pictures and displays the decoded pictures in real time includes measuring time during a decoding process; providing a normal decoding function for performing a normal decoding process and a simple decoding function for performing a simple decoding process that decodes a bidirectional prediction macro block of MPEG at high speed in a short time by using only one of two reference pictures; performing a decoding operation with temporary stopping during the decoding process; and in accordance with the measured time, switching the decoding operation to either the normal decoding process or the simple decoding process during the decoding process. Thus, a video decoder compatible with, for example, 4:2:2P@HL can be realized effectively.

According to a fourteenth aspect of the invention, the decoding method further includes stopping the decoding operation in each MPEG slice unit of the digitally compressed and encoded pictures; and switching the decoding operation to either the normal decoding process or the simple decoding process in each of the MPEG slice units. Thus, the decoding process in the slice unit can be executed properly.

According to a fifteenth aspect of the invention, the decoding method further includes stopping the decoding operation in each MPEG macro block unit of the digitally compressed and encoded pictures; and switching the decoding operation to either the normal decoding process or the simple decoding process in each of the MPEG macro block units. Thus, the decoding process in the macro block unit can be executed properly.

According to a sixteenth aspect of the invention, only the normal decoding process is used for a specific picture to be used as a reference picture during picture compression/expansion for decoding another picture, and if a decoding process time of the specific picture is longer than a display time of one picture frame, the decoding process times of pictures preceding and subsequent to the specific picture are shortened by the simple decoding process. Thus, decoding with few failures can be realized.

In this manner, the present invention can readily eliminate the drawbacks of a conventional apparatus, the drawbacks being inevitable image quality deterioration to a great degree because the decoding process is terminated when a predetermined time (one frame period) has lapsed, and also serious failures of decoding when this countermeasure is performed for an I picture and a P picture.

### BRIEF DESCRIPTION OF THE DRAWINGS

FIG. 1 is a block diagram showing the structure of a system for decoding a video picture encoded, for example, by the MPEG2 format and reproducing it in real time, the system adopting a decoding apparatus and a decoding method according to embodiments of the present invention;

FIG. 2 is a flow chart illustrating the operation of the system of FIG. 1;

FIG. 3 is a diagram illustrating the decoding processing sequence;

FIG. 4 is a diagram illustrating a change in the data in the frame buffer;

FIG. 5 is a diagram illustrating dual-direction motion prediction coding;

FIG. 6 is a diagram illustrating the upper limit value of each parameter relative to each profile and each level of MPEG2;

FIG. 7 is a diagram illustrating the hierarchical structure of an MPEG2 bit stream;

FIG. 8 is a diagram illustrating a macro block layer.

FIG. 9 is a diagram illustrating the data structure of a sequence_header;

FIG. 10 is a diagram illustrating the data structure of a sequence_extension.

FIG. 11 is a diagram illustrating the data structure of a GOP_header;

FIG. 12 is a diagram illustrating the data structure of a picture_header;

FIG. 13 is a diagram illustrating the data structure of a picture_coding_extension.

FIG. 14 is a diagram illustrating the data structure of a picture_data;

FIG. 15 is a diagram illustrating the data structure of a slice;

FIG. 16 is a diagram illustrating the data structure of a macroblock;

FIG. 17 is a diagram illustrating the data structure of macroblock_modes;

FIG. 18 is a diagram illustrating start codes;

FIG. 19 is a block diagram showing the structure of a conventional video decoder for decoding an MP@ML encoded stream; and

FIG. 20 is a block diagram showing the structure of a video decoder previously proposed by the present applicant.

### DETAILED DESCRIPTION

The decoding apparatus of the present invention is to be used in a system that decodes digitally compressed and encoded pictures and displays the decoded pictures in real time, including a decoding control section having a function for measuring a time during a decoding process; and a decoding processing section for performing a decoding operation with temporary stopping during the decoding process, in cooperation with the decoding control section; wherein the decoding processing section further has a simple decoding function for performing a simple decoding process that decodes at high speed in a short time, in addition to a normal decoding function for performing a normal decoding process; and in accordance with an instruction from the decoding control section, the decoding operation of the decoding processing section is able to be switched to either the normal decoding process or the simple decoding process during the decoding process.

Further, the decoding apparatus of the present invention is to be used in a system that decodes digitally compressed and encoded pictures and displays the decoded pictures in real time, including a decoding control section having a function of measuring a time during a decoding process; and a decoding processing section for performing a decoding operation with temporary stopping during the decoding process, in cooperation with the decoding control section; wherein the decoding processing section further has a simple decoding function for performing a simple decoding process that decodes a bidirectional prediction macro block of MPEG at high speed in a short time by using only one of two reference pictures, in addition to a normal decoding function for performing a normal decoding process; and in accordance with an instruction from the decoding control section, the decoding operation of the decoding processing section is able to be switched to either the normal decoding process or the simple decoding process during the decoding process.

Further, the decoding method of the present invention is to be used in a system that decodes digitally compressed and encoded pictures and displays the decoded pictures in real time, including the steps of measuring a time during a decoding process; and performing a decoding operation with temporary stopping during the decoding process, in cooperation with a decoding control section; wherein a simple decoding function is provided for performing a simple decoding process that decodes at high speed in a short time, in addition to a normal decoding function for performing a normal decoding process; and in accordance with the measured time, the decoding operation is able to be switched to either the normal decoding process or the simple decoding process during the decoding process.

Further, the decoding method of the present invention is to be used in a system that decodes digitally compressed and encoded pictures and displays the decoded pictures in real time, including the steps of measuring a time during a decoding process; and performing a decoding operation with temporary stopping during the decoding process; wherein a simple decoding function is provided for performing a simple decoding process that decodes a bidirectional prediction macro block of MPEG at high speed in a short time by using only one of two reference pictures, in addition to a normal decoding function for performing a normal decoding process; and in accordance with the measured time, the decoding operation is able to be switched to either the normal decoding process or the simple decoding process during the decoding process.

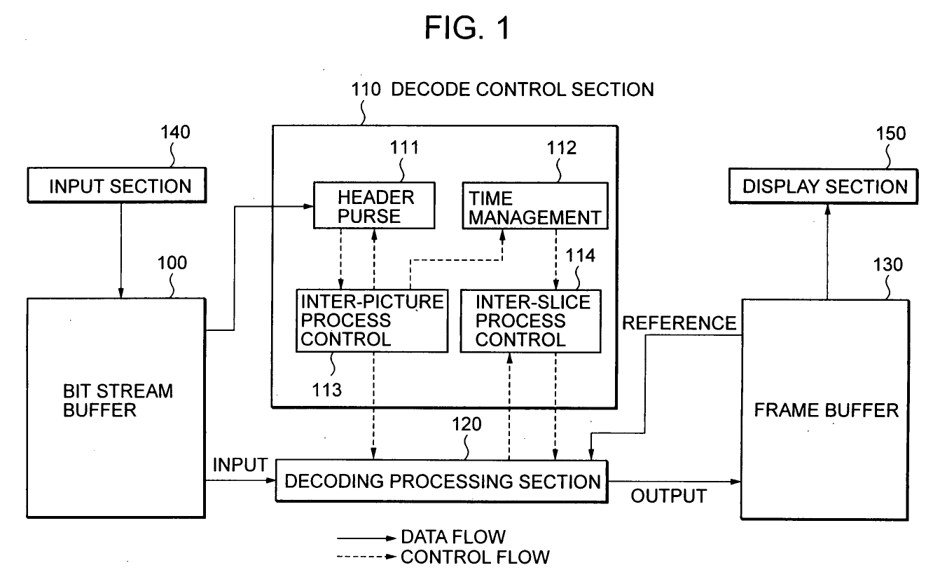

In the following, the present invention will be described with reference to the drawings. FIG. 1 is a block diagram showing the structure of a system for decoding a video picture encoded, for example, by the MPEG2 format and reproducing it in real time, the system adopting the decoding apparatus and the decoding method according to embodiments of the present invention.

Referring to FIG. 1, the system consists of four blocks including a bit stream buffer 100, a decoding control section 110, a decoding processing section 120 and a frame buffer 130, in addition to an input section 140 and a display section 150. The bit stream buffer 100 is a memory for storing a video Elementary Stream (hereinafter, “video ES”) obtained from the input section 140 before decoding.

The frame buffer 130 is a memory for storing a video picture after decoding. The decoding processing section 120 is the main section for executing a decoding process, reads data from the bit stream buffer 100, and writes the picture in the frame buffer 130 after decoding. When a P picture and a B picture are decoded, a reference picture is read from the frame buffer 130.

The system temporarily stops the operation each time data of one slice is processed, and waits for an instruction from the decoding control section 110. Thereafter, in accordance with the instruction, the process continues or is terminated. Namely, the decoding control section 110 is a block having the central core of the present invention, and controls the operation of the decoding processing section 120.

In decoding, first a header purse section 111 reads data from the bit stream buffer 100 and purses the headers of the picture layer and upper level layers. After the header purse is completed and when a decode start time is notified from a time management section 112, an inter-picture process control section 113 activates the operation of the decoding processing section 120.

At this time, the inter-picture process control section 113 provides the decoding processing section 120 with information on which position of the bit stream buffer 100 the video ES is read from and information on which picture in the frame buffer 130 is used as a reference picture. A decode start is also provided to the time management section 112.

When the operation of the decoding processing section 120 temporarily stops, a notice to this effect is received by an inter-slice process control section 114. The inter-slice process control section 114 determines whether the decoding process is continued, continued by a simple decoding process, or stopped. When all slices in one picture have been processed, a notice to this effect is supplied from the inter-slice process control section 114 to the inter-picture process control section 113.

The time management section 112 generates a decode start time (frame sync signal) and measures a lapsed time after the decode start. When the decode start time comes, the inter-picture process control section 113 is notified of this. In response to a request from the inter-slice process control section 114, the lapsed time after the decode start and the remaining time until the next frame sync signal is generated are notified.

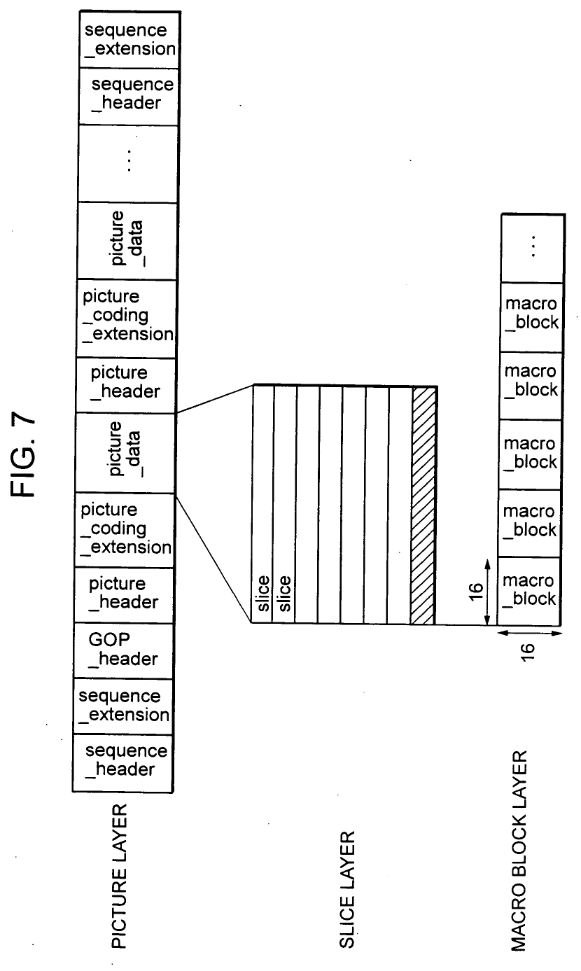

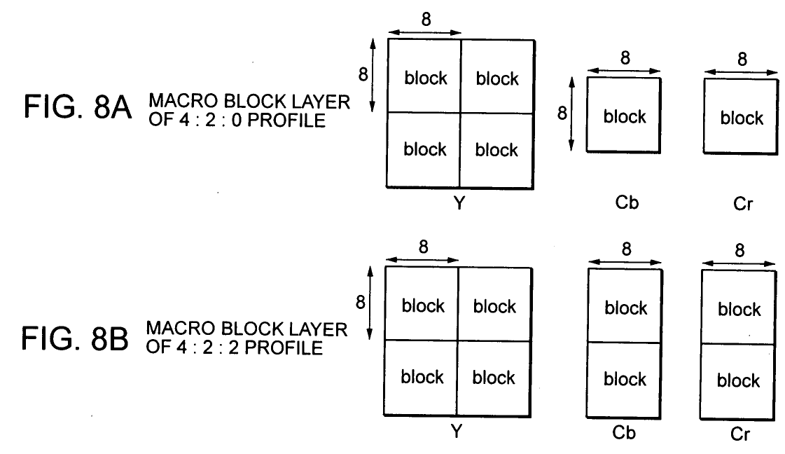

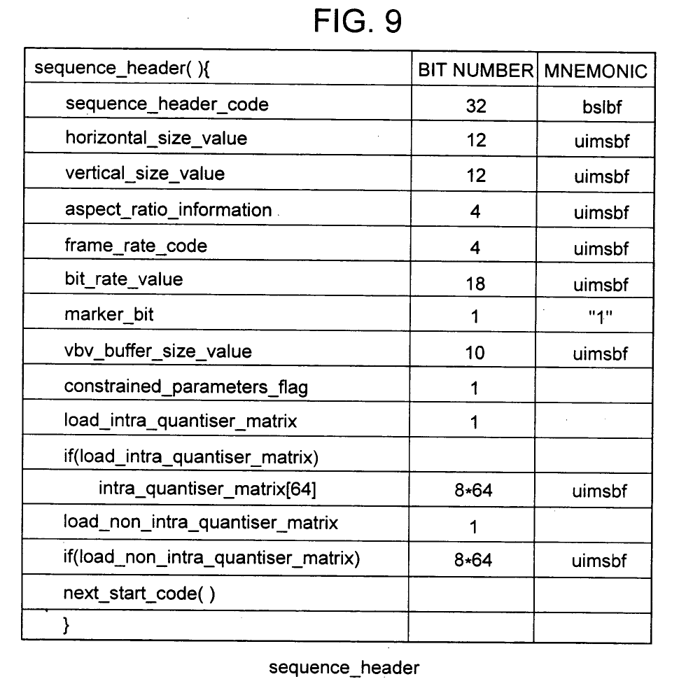

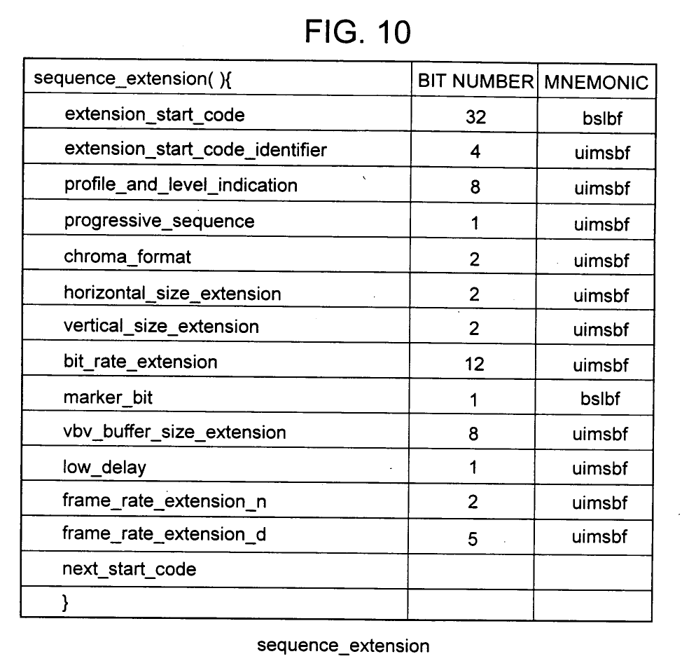

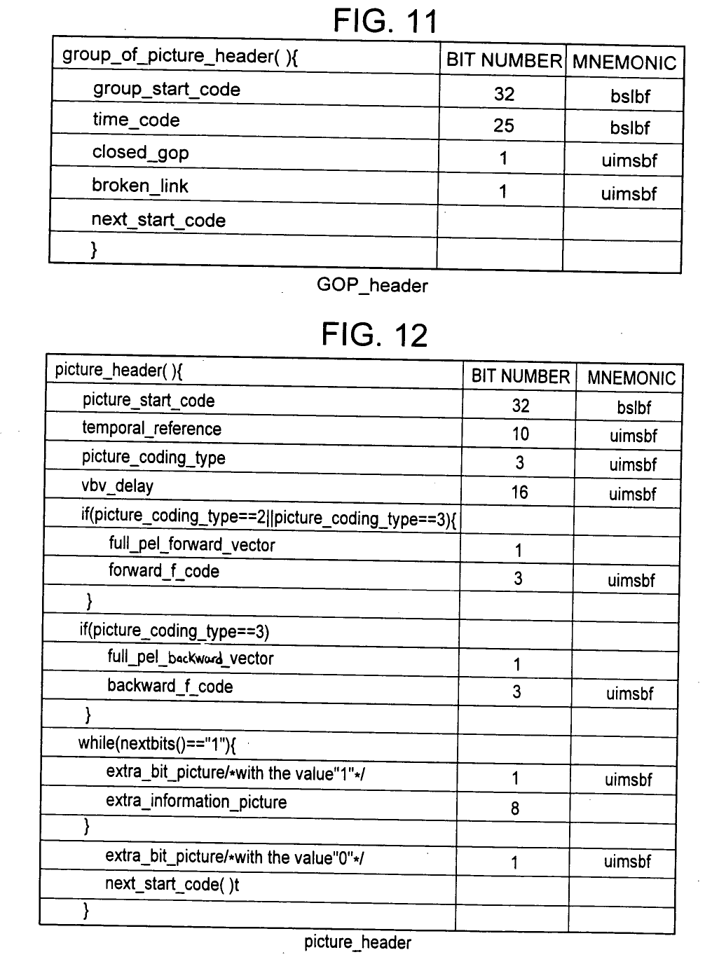

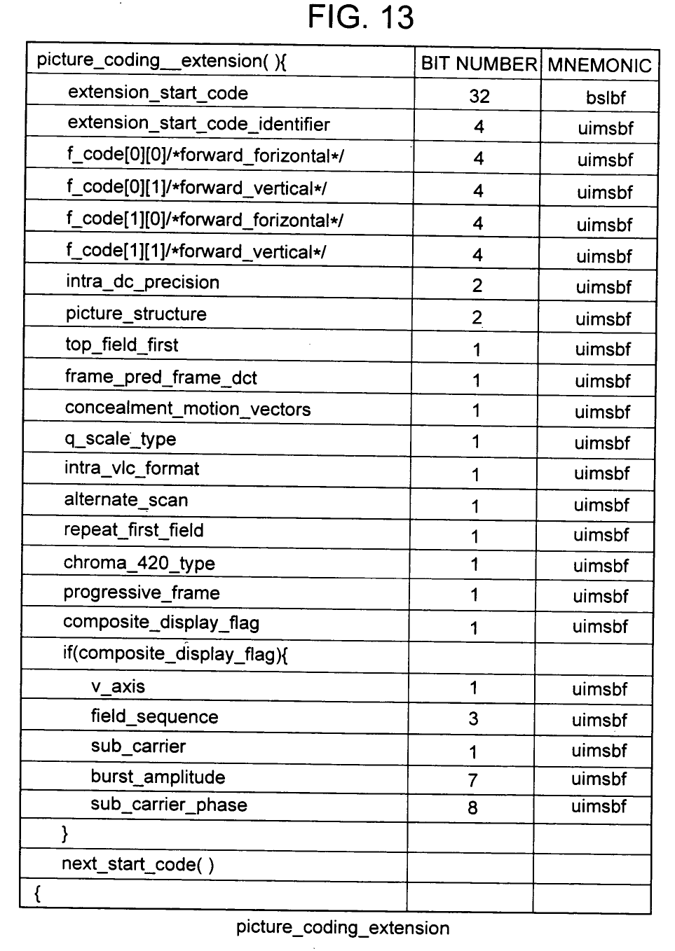

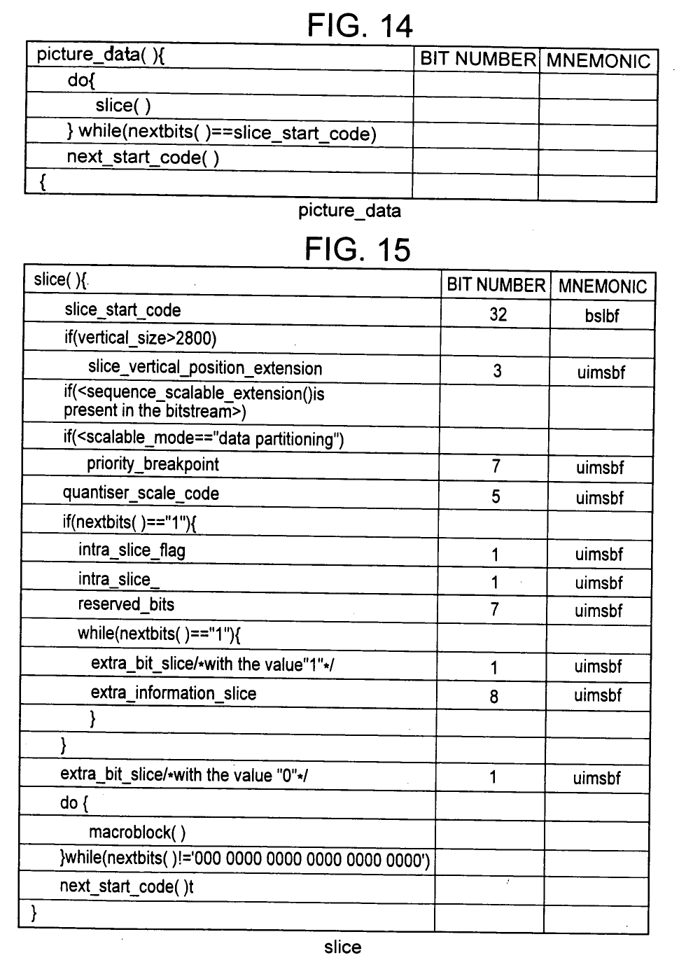

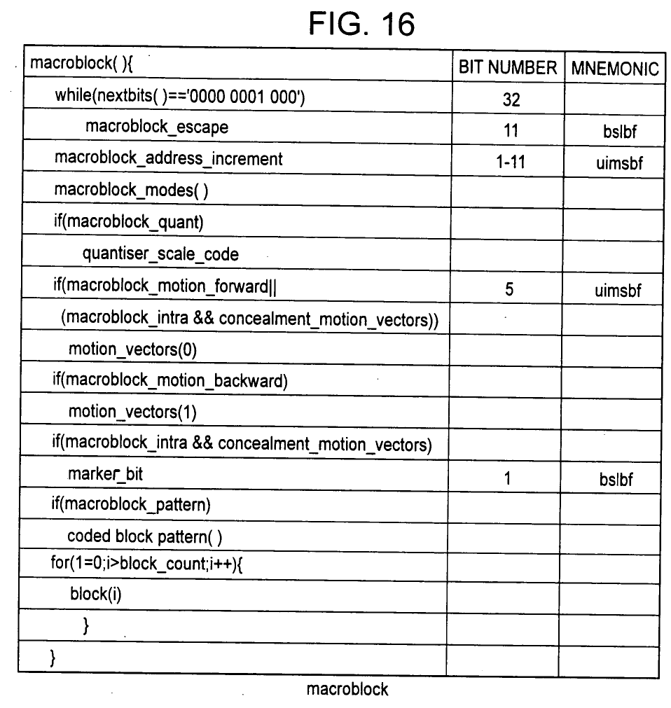

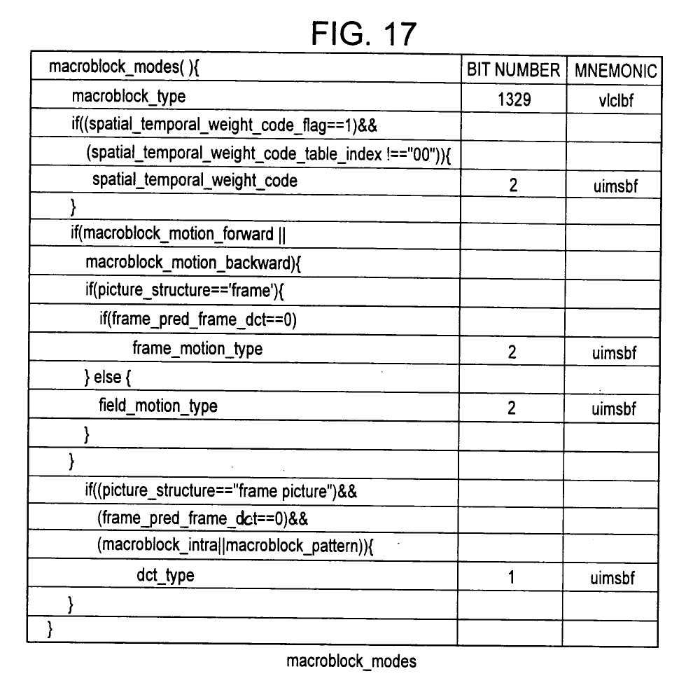

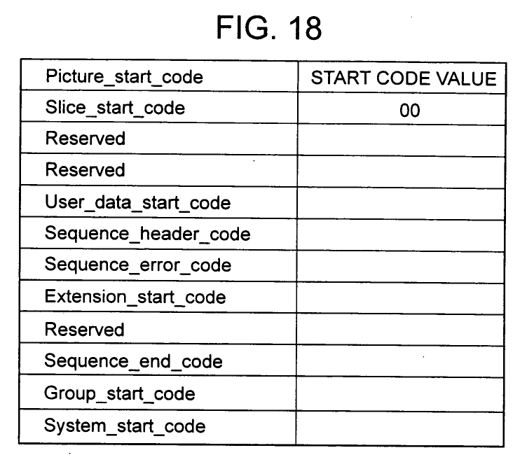

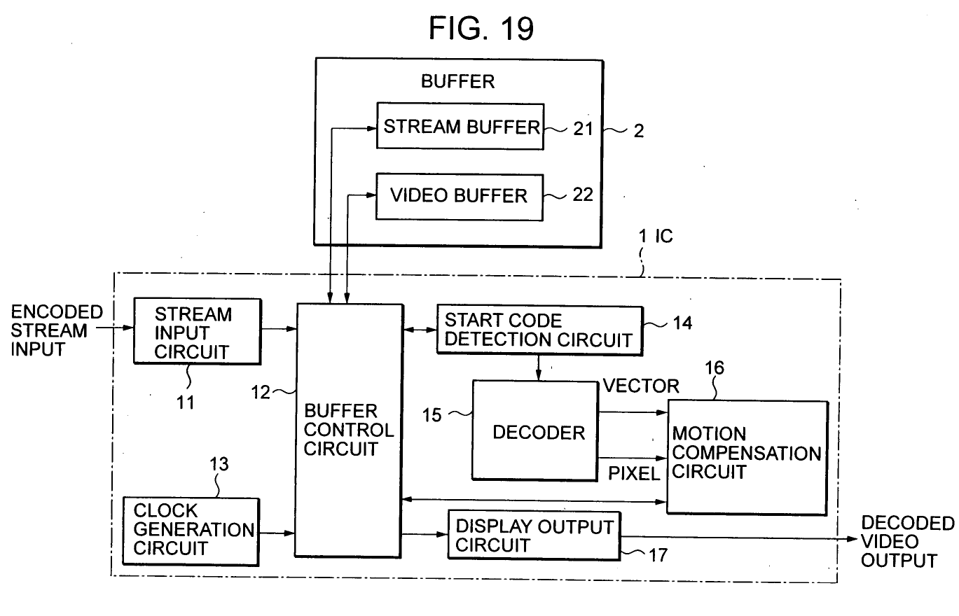

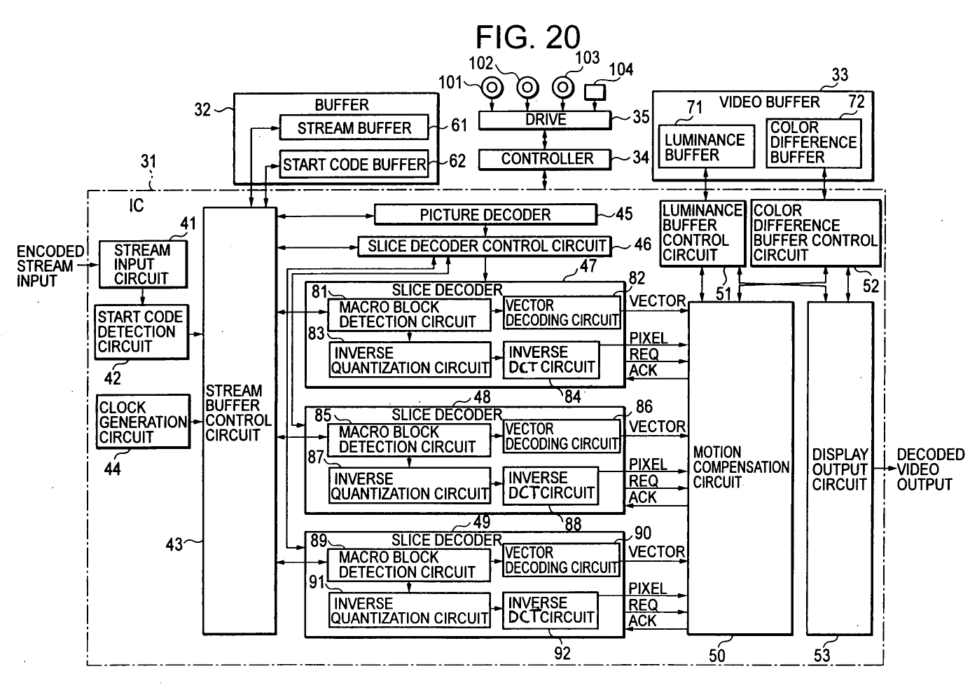

An MPEG video as the subject matter of this application has the hierarchical data structure shown in FIG. 7 described above, and a sequence layer is positioned at the highest level. The sequence header of the sequence layer contains information on the number of pixels in the horizontal direction, the number of pixels in the vertical direction and a frame rate code, and this information is extracted by the header purse section 111. For example, a picture of a 480I format of digital broadcasting has 720×480 pixels and a frame rate of 29.97 Hz.

The header purse section 111 passes the frame rate to the time management section 112, and the time management section 112 sets the interval of the frame sync signal to 1/29.97 second. The header purse section 111 also passes the number of pixels to the inter-slice process control section 114, and the inter-slice process control section 114 determines that it is sufficient to process (720/16)×(480/16)=45×30=1350 macro blocks (hereinafter abbreviated into “MB”) before the next frame sync signal comes.

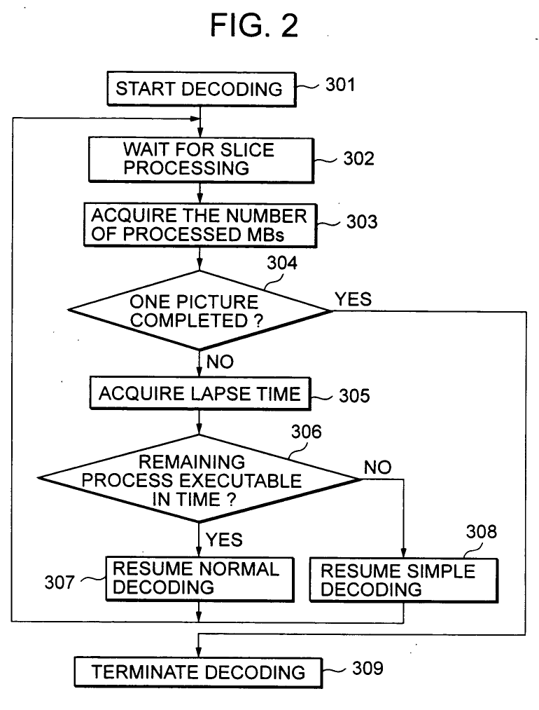

FIG. 2 shows the operation flow of the inter-slice process control section 114 which is the main portion when the present invention is embodied.

At Step 301 the inter-picture process control section 113 activates the decoding processing section 120, and thereafter at Step 302 the inter-slice process control section 114 waits for a slice completion notice from the decoding processing section 120. Upon reception of the slice completion notice, at Step 303 the number of decoded MBs is acquired from the decoding processing section 120.

The number of MBs is the total number of MBs already decoded until this time. If the number of MBs is equal to the number of MBs of one picture passed from the header purse section 111, it is determined at Step 304 that the decoding of one picture has been completed, and at Step 309 a notice to this effect is sent to the inter-picture process control section 113 and decoding is terminated. If smaller, it is determined that the decoding process is in the intermediate state, and the process continues.

If the decoding process is in the intermediate state, at Step 305 the lapsed time after the decode start is acquired from the time management section 112. At the same time, the remaining time until the next frame sync signal is generated is acquired. Thereafter, at Step 306 it is determined from the lapsed time and the number of processed MBs whether the decoding processing section 120 can process the remaining MBs at this pace.

This determination is made, for example, by the following calculations. Namely, the normal decoding process is performed until the decoding time exceeds the remaining half, and when the decoding time exceeds the remaining half, the following calculations are performed:
Tmb_mean=Tpast/MBnum
   where Tmb_mean is an average process time per 1 MB;
Tpast is the lapsed time after decode start; and
Mbnum is the number of MBs already processed.
Tmore=Tmb_mean*(MBtotal−MBnum)
   where Tmore is the remaining time necessary for processing at the present pace; and
Mbtotal is the total number of MBs to be decoded.
Tratio=(Tpast+Tmore)/(Tpast+Trest)*100 [symbol]
   where Tratio is a ratio between a total time and a limit time when processing is performed at the present pace; and
Trest is the remaining time until the limit time.

If Tratio exceeds 100%, the next slice is subjected to the simple decoding process, whereas if not, the next slice is subjected to the normal decoding process. That is, if the remaining MBs can be processed by the decoding processing section 120 at this pace, the normal decoding process resumes at Step 307, whereas if they cannot be processed, the decoding processing section 120 resumes a process by using the simple decoding process at Step 308. Thereafter, at Step 302 a slice completion notice from the decoding processing section 120 is awaited.

According to this embodiment, therefore, for the real time display of a picture digitally compressed and encoded, a time during the decoding process is measured, and a simple decoding function is provided which can perform the decoding operation with temporary stopping during the decoding process and execute the decoding process at high speed in a short time, in addition to the normal decoding process. Since the decoding operation can be switched during the decoding process in accordance with the measured time, a video decoder compatible with, e.g., 4:2:2P@HL can be realized effectively.

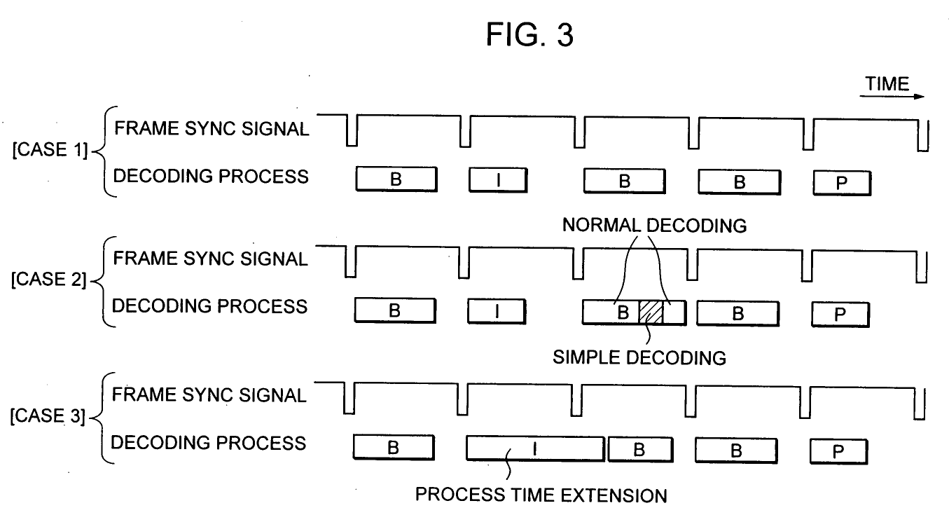

FIG. 3 shows the decoding process sequences in the picture unit. Case 1 shows that decoding of all pictures is normally completed. In contrast, case 2 shows that decoding a B picture requiring a long process time is changed to the simple decoding at the intermediate point. Case 2 also shows that the normal decoding resumes if the process time becomes sufficient at the intermediate point of the simple decoding.

In the above-described embodiment, the simple decoding is not applied to the I and P pictures. That is, since the I and P pictures are used as the reference picture to be used for decoding another P or B picture, the I and P pictures are decoded even by prolonging the process time. Therefore, even if the inter-picture process control section 113 receives a decode start notice from the time management section 112 and if the I or P picture is being decoded, this decoding continues.

Decoding of the next picture starts immediately after the decoding in progress is completed. In order to realize this, the display section 150 of the system starts displaying after a delay of several frames after the decoding completion. In this manner, jitter of the decoding process time is absorbed by the frame buffer 130 and the display section 150 continues to display pictures at a constant rate. Case 3 shown in FIG. 3 shows that the decoding process for the I picture is prolonged and decoding of the next B picture starts at a delayed time from the frame sync signal.

In this manner, the present invention can readily eliminate the drawbacks of a conventional apparatus, the drawbacks being inevitable image quality deterioration to a great degree because the decoding process is terminated when a predetermined time (one frame period) lapses, and serious failures of decoding when this countermeasure is performed for a so-called I picture and P picture.

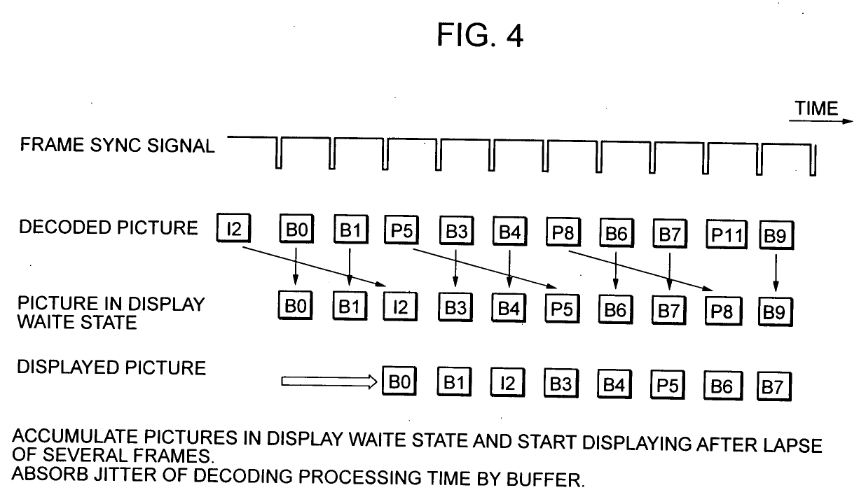

FIG. 4 shows a change in the data in the frame buffer 130. In FIG. 4, of the decoded pictures, the B picture immediately enters a display wait state. In contrast, the I and P pictures enter the display wait state after the decoding of the succeeding B pictures has been completed. Thus, according to the present invention, the picture in the display wait state is not immediately displayed, but it is displayed after a delay of several frames.

Therefore, in the steady state of the data in the frame buffer 130, frames corresponding in number to the display delay stand by in the display wait state. The number of wait frames increases if the decoding of a picture is completed fast, whereas it is reduced if the decoding of a picture is completed slowly. In this manner, even if it takes a long time to decode the I and P pictures, pictures can be displayed continuously on the display section 150 without intermittence, unless the number of wait frames becomes 0.

In the following, the simple decoding method will be described. Thus, for example, in MPEG, a sequence consists of a plurality of GOPs (Group Of Pictures) each consisting of a plurality of pictures. Pictures include three types I, P and B. The I and P pictures are used as reference pictures for decoding another P picture and the B pictures. Since a B picture is not used as a reference picture, even if the decoded B picture is distorted, the decoding of another picture will not be influenced.

According to the present invention, therefore, the time management section 112 measures the decoding process time of a B picture, and if the decoding process is assumed not to be completed in the time limit for the real time operation, the inter-slice process control section 114 controls the decoding processing section 120 so that the remaining process is performed at high speed by the simple decoding. The B picture is a picture encoded by two forward and backward reference pictures. In the simple decoding, for example, only one reference picture is used to reduce the number of memory accesses of the frame buffer 130 from the decoding processing section 120 and the calculation amount by the decoding processing section 120.

Each picture consists of a plurality of slices. The decoding processing section 120 temporarily stops each time a slice process has been completed, and waits for an instruction from the inter-slice process control section 114. In accordance with the instruction, one of the operations is executed, an operation of normally decoding the next slice, an operation of processing the next slice at high speed by the simple decoding, or an operation of terminating the decoding process for all remaining slices to complete the processing of one picture.

Each slice consists of a plurality of MBs. The slice is a set of macro blocks each including 16×16 pixels. One slice consists of MBs continuously disposed on a screen from the left to right and from the upper to the lower. An MB is encoded by motion compensation prediction. Several MB prediction method types exist—no motion compensation prediction, a forward direction (prediction using a forward reference picture), a backward direction (prediction using a backward reference picture), a dual-direction (prediction using both forward and backward reference pictures) and the like.

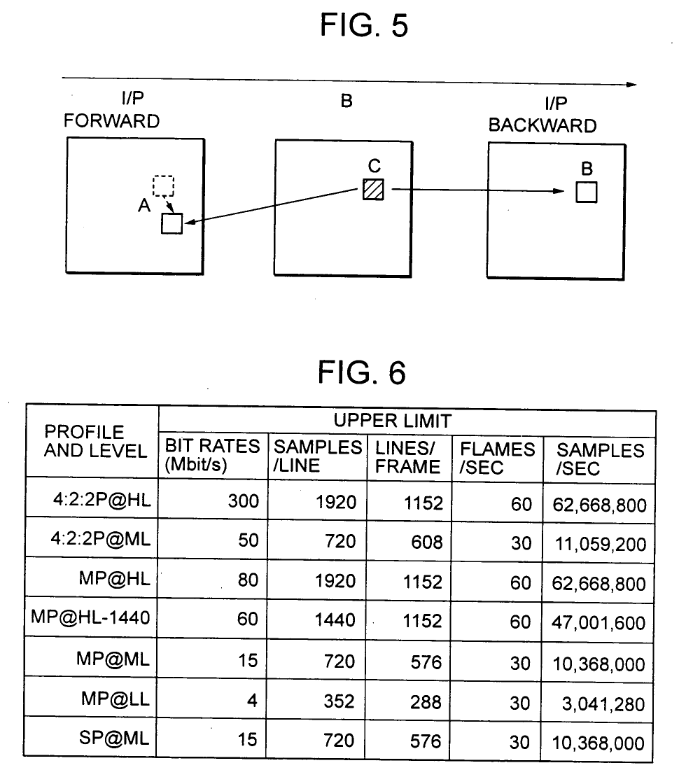

In the encoding using motion compensation prediction, as shown in FIG. 5, the forward and backward I/P pictures relative to the B picture during encoding are used as the reference pictures, and compression is performed by acquiring the differences between an MB under processing and MBs of the corresponding forward and backward I/P pictures. In this case, information designating the referenced forward, backward or both pictures and information of the motion vectors of the MB between the referenced pictures are described in the header of the B picture.

In decoding a picture, a corresponding MB is determined from the picture designating information and motion vector information, and the original image data is formed from the difference information by using the determined MB. In this case, if reference to the dual-direction is designated, the MB is determined from the motion vectors relative to the reference pictures, and the data of the MB to be referred to is formed by calculating the average values thereof.

According to the present invention, therefore, attention is paid to a bidirectional prediction MB. Only one reference picture is used when the bidirectional prediction MB existing in a B picture is decoded. Which one is selected is determined by any method, including a method which always selects only the forward picture, or a method which adaptatively selects one reference picture corresponding to the reference picture used when the MB on one line up or the MB to the left by 1 MB was decoded.

According to a search made by the present inventor, the probability that the bidirectional prediction is performed for the B picture in a general video signal is about 60%. This B picture is decoded through one direction prediction to reduce the number of accesses to the memory. A reduction in the calculation time by changing the bidirectional prediction to one direction prediction is about 30%. It is therefore expected that the whole process time can be reduced by a fairly large amount.

According to this embodiment, therefore, for the real time display of a picture digitally compressed and encoded, a time during the decoding process is measured, and the simple decoding function capable of operating in a short time at high speed, in addition to the normal decoding process, is provided which temporarily stops during the decoding process and executes a decoding operation. Since the decoding operation can be switched during the decoding process in accordance with the measured time, a video decoder compatible with, e.g., 4:2:2P@HL can be realized effectively.

In this manner, the present invention can readily eliminate the drawbacks of a conventional apparatus, the drawbacks being inevitable image quality deterioration to a great degree because the decoding process is terminated when a predetermined time (one frame period) lapses, and serious failures of decoding when this countermeasure is performed also for an I picture and a P picture.

In the above description, the decoding processing section 120 temporarily stops the decoding process and passes a control privilege to the decoding control section 110 in the slice unit. The control privilege may be passed in an MB unit. In this case, the unit of performing the simple decoding is not the slice unit but the MB unit.

According to the present invention, decoding of a picture whose decoding cannot be completed in a limited time is changed to the simple decoding process in the intermediate state. As compared to the method which forms a portion not decoded and replaces the portion with the past decoded picture, the image quality deterioration can be suppressed. In particular, the present invention is effective for use with an image having an active motion.

A picture to be used later as the reference picture is decoded completely, even if the process time exceeds the time limit so that the image quality deterioration will not influence another picture.

The decoding apparatus described above is to be used in a system that decodes digitally compressed and encoded pictures and displays the decoded pictures in real time, including a decoding control section having a function for measuring time during a decoding process; and a decoding processing section for performing a decoding operation with temporary stopping during the decoding process in cooperation with the decoding control section; wherein, in addition to a normal decoding function for performing a normal decoding process, the decoding processing section has a simple decoding function for performing a simple decoding process that decodes at high speed in a short time; and in accordance with an instruction from the decoding control section, the decoding operation of the decoding processing section is able to be switched during the decoding process to either the normal decoding process or the simple decoding process. Thus, a video decoder compatible with, for example, 4:2:2P@HL can be realized effectively.

Further, the above-described decoding apparatus is to be used in a system that decodes digitally compressed and encoded pictures and displays the decoded pictures in real time, including a decoding control section having a function of measuring time during a decoding process; and a decoding processing section for performing a decoding operation with temporary stopping during the decoding process in cooperation with the decoding control section; wherein, in addition to a normal decoding function for performing a normal decoding process, the decoding processing section has a simple decoding function for performing a simple decoding process that decodes a bidirectional prediction macro block of MPEG at high speed in a short time by using only one of two reference pictures; and in accordance with an instruction from the decoding control section, the decoding operation of the decoding processing section is able to be switched during the decoding process to either the normal decoding process or the simple decoding process. Thus, a video decoder compatible with, for example, 4:2:2P@HL can be realized effectively.

The above-described decoding method is to be used in a system that decodes digitally compressed and encoded pictures and displays the decoded pictures in real time, including the steps of measuring time during a decoding process; and performing a decoding operation with temporary stopping during the decoding process in cooperation with the decoding control section; wherein, in addition to a normal decoding function for performing a normal decoding process, a simple decoding function is provided for performing a simple decoding process that decodes at high speed in a short time; and in accordance with the measured time, the decoding operation is able to be switched during the decoding process to either the normal decoding process or the simple decoding process. Thus, a video decoder compatible with, for example, 4:2:2P@HL can be realized effectively.

Further, the above-described decoding method is to be used in a system that decodes digitally compressed and encoded pictures and displays the decoded pictures in real time, including the steps of measuring time during a decoding process; and performing a decoding operation with temporary stopping during the decoding process; wherein, in additional to a normal decoding function for performing a normal decoding process, a simple decoding function is provided for performing a simple decoding process that decodes a bidirectional prediction macro block of MPEG at high speed in a short time by using only one of two reference pictures; and in accordance with the measured time, the decoding operation is able to be switched during the decoding process to either the normal decoding process or the simple decoding process. Thus, a video decoder compatible with, for example, 4:2:2P@HL can be realized effectively.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A decoding apparatus to be used in a system that decodes digitally compressed and encoded pictures and displays the decoded pictures in real time, the decoding apparatus comprising:
a decoding control section operable to measure time during a decoding process; and
a decoding processing section operable to perform a decoding operation with temporary stopping during the decoding process in cooperation with the decoding control section; wherein
the decoding processing section is operable to perform both a normal decoding process and a simple decoding process that decodes at a higher speed and in a shorter time than the normal decoding process, and
the decoding control section is operable to switch the decoding operation of the decoding processing section to either the normal decoding process or the simple decoding process during the decoding process.

2. The decoding apparatus according to claim 1, wherein
the decoding processing section is operable to stop the decoding operation in each MPEG slice unit of the digitally compressed and encoded pictures, and
the decoding control section is operable to switch the decoding operation of the decoding processing section to either the normal decoding process or the simple decoding process in each of the MPEG slice units.

3. The decoding apparatus according to claim 1, wherein
the decoding processing section is operable to stop the decoding operation in each MPEG macro block unit of the digitally compressed and encoded pictures, and
the decoding control section is operable to switch the decoding operation of the decoding processing section to either the normal decoding process or the simple decoding process in each of the MPEG macro block units.

4. The decoding apparatus according to claim 1, wherein
only the normal decoding process is used for a specific picture to be used as a reference picture during picture compression/expansion for decoding another picture, and
if a decoding process time of the specific picture is longer than a display time of one picture frame, the decoding process times of pictures preceding and subsequent to the specific picture are shortened by the simple decoding process.

5. A decoding apparatus to be used in a system that decodes digitally compressed and encoded pictures and displays the decoded pictures in real time, the decoding apparatus comprising:
a decoding control section operable to measure time during a decoding process; and
a decoding processing section operable to perform a decoding operation with temporary stopping during the decoding process in cooperation with the decoding control section; wherein
the decoding processing section is operable to perform both a normal decoding process and a simple decoding process that decodes a bidirectional prediction macro block of MPEG at a higher speed and in a shorter time than the normal decoding process by using only one of two reference pictures, and
the decoding control section is operable to switch the decoding operation of the decoding processing section to either the normal decoding process or the simple decoding process during the decoding process.

6. The decoding apparatus according to claim 5, wherein
the decoding processing section is operable to stop the decoding operation in each MPEG slice unit of the digitally compressed and encoded pictures, and
the decoding control section is operable to switch the decoding operation of the decoding processing section to either the normal decoding process or the simple decoding process in each of the MPEG slice units.

7. The decoding apparatus according to claim 5, wherein
the decoding processing section is operable to stop the decoding operation in each MPEG macro block unit of the digitally compressed and encoded pictures, and
the decoding control section is operable to switch the decoding operation of the decoding processing section to either the normal decoding process or the simple decoding process in each of the MPEG macro block units.

8. The decoding apparatus according to claim 5, wherein
only the normal decoding process is used for a specific picture to be used as a reference picture during picture compression/expansion for decoding another picture, and
if a decoding process time of the specific picture is longer than a display time of one picture frame, the decoding process times of pictures preceding and subsequent to the specific picture are shortened by the simple decoding process.

9. A decoding method to be used in a system that decodes digitally compressed and encoded pictures and displays the decoded pictures in real time, the method comprising:
measuring time during a decoding process;
providing a normal decoding function for performing a normal decoding process and a simple decoding function for performing a simple decoding process, the simple decoding process decoding at a higher speed and in a shorter time than the normal decoding process;
performing a decoding operation with temporary stopping during the decoding process; and
in accordance with the measured time, switching the decoding operation to either the normal decoding process or the simple decoding process during the decoding process.

10. The decoding method according to claim 9, further comprising
stopping the decoding operation in each MPEG slice unit of the digitally compressed and encoded pictures; and
switching the decoding operation to either the normal decoding process or the simple decoding process in each of the MPEG slice units.

11. The decoding method according to claim 9, further comprising
stopping the decoding operation in each MPEG macro block unit of the digitally compressed and encoded pictures; and
switching the decoding operation to either the normal decoding process or the simple decoding process in each of the MPEG macro block units.

12. The decoding method according to claim 9, wherein
only the normal decoding process is used for a specific picture to be used as a reference picture during picture compression/expansion for decoding another picture, and
if a decoding process time of the specific picture is longer than a display time of one picture frame, the decoding process times of pictures preceding and subsequent to the specific picture are shortened by the simple decoding process.

13. A decoding method to be used in a system that decodes digitally compressed and encoded pictures and displays the decoded pictures in real time, the method comprising:
measuring time during a decoding process;
providing a normal decoding function for performing a normal decoding process and a simple decoding function for performing a simple decoding process that decodes a bidirectional prediction macro block of MPEG at high speed in a short time by using only one of two reference pictures;
performing a decoding operation with temporary stopping during the decoding process; and
in accordance with the measured time, switching the decoding operation to either the normal decoding process or the simple decoding process during the decoding process.

14. The decoding method according to claim 13, further comprising
stopping the decoding operation in each MPEG slice unit of the digitally compressed and encoded pictures; and
switching the decoding operation to either the normal decoding process or the simple decoding process in each of the MPEG slice units.

15. The decoding method according to claim 13, further comprising
stopping the decoding operation in each MPEG macro block unit of the digitally compressed and encoded pictures; and
switching the decoding operation to either the normal decoding process or the simple decoding process in each of the MPEG macro block units.

16. The decoding method according to claim 13, wherein
only the normal decoding process is used for a specific picture to be used as a reference picture during picture compression/expansion for decoding another picture, and
if a decoding process time of the specific picture is longer than a display time of one picture frame, the decoding process times of pictures preceding and subsequent to the specific picture are shortened by the simple decoding process.
